(19) United States
(12) Patent Application Publication
(10) Pub. No.: US 2021/0163172 A1
(43) Pub. Date: Jun. 3, 2021

(54) CARTON WITH INTEGRATED PARTITION AND RELATED METHODS

(71) Applicant: Veritiv Operating Company, Sandy Springs, GA (US)

(72) Inventors: Jason Jack Hallman, Plainfield, IL (US); Francesco DiTerlizzi, Lombard, IL (US)

(21) Appl. No.: 17/106,795

(22) Filed: Nov. 30, 2020

Related U.S. Application Data
(60) Provisional application No. 62/942,412, filed on Dec. 2, 2019.

(51) Int. Cl. B65D 5/48; B65D 5/36; B31B 50/26; B31B 50/62; B31B 50/78

(52) U.S. Cl. CPC B65D 5/48008; B65D 5/3621; B31B 2120/302; B31B 50/624; B31B 50/782; B31B 50/26

(57) ABSTRACT

Disclosed is a carton with an integrated partition formed from a single blank and that can be erected from a folded and glued configuration in a single step. The unerected carton is configured so it snaps automatically into an erected carton with integrated partition when a user simply applies slight pressure to the corners of the unerected carton. The erected carton with integrated partition can then be easily collapsed into the unerected configuration by simply squeezing opposing sides of the erected partition about the corners. Since the carton with integrated partition is configured to move easily and automatically between the unerected and erected positions, the carton with integrated partition is suitable for repeated use.

### CROSS-REFERENCE TO RELATED APPLICATION

This application claims the benefit of and priority to U.S. Provisional Patent Application No. 62/942,412 filed Dec. 2, 2019, the entire contents of which are hereby incorporated herein by this reference.

### TECHNICAL FIELD

This application relates to paperboard cartons with integrated partitions and related methods.

### BACKGROUND

Partitions may be used in the interior of a carton to create a plurality of cells that separate the contents of the carton from one another. For example, a partition may be used to separate glass bottles or other breakable or damage-prone items. Existing partitions require that a user manually fold and assemble individual pieces to form a partition, and then place the partition into a separate carton.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this application, and any or all drawings or figures.

Disclosed are cartons with integrated partitions formed from a single blank. The blank is glued and folded to form an unerected carton with integrated partition. The unerected carton is configured so it snaps automatically into an erected carton with an integrated partition when a user simply applies force to opposing corners of the unerected carton. Since the partition is integrated with the carton and the integrated unit is erected during a one-step forming process, there is no need to assemble various components to form the partition or to assemble the erected unit with another carton. The erected carton with integrated partition can then be easily collapsed into the unerected configuration by squeezing/pressing together adjacent sides of the erected partition about the corners. Because the carton with integrated partition moves easily and automatically between the unerected and erected positions, the carton with integrated partition can be used repeatedly without deassembly or reassembly, as is required with existing partitions.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a plan view of an embodiment of a unitary blank of a foldable material that may be folded and glued to form an unerected carton with integrated partition.

FIG. 2 is a plan view of another embodiment of a unitary blank of a foldable material that may be folded and glued to form an unerected carton with integrated partition.

FIG. 3 is a plan view of another embodiment of a unitary blank of a foldable material that may be folded and glued to form an unerected carton with integrated partition.

FIG. 4 is a plan view of another embodiment of a unitary blank of a foldable material that may be folded and glued to form an unerected carton with integrated partition.

FIG. 5 is a perspective view of an unerected carton with integrated partition formed from the blank of FIG. 1.

FIG. 6 is a perspective view of an erected carton with integrated partition formed from the unerected carton of FIG. 5.

FIG. 7 is a perspective view illustrating an unerected carton with integrated partition as it is being erected into an erected carton.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

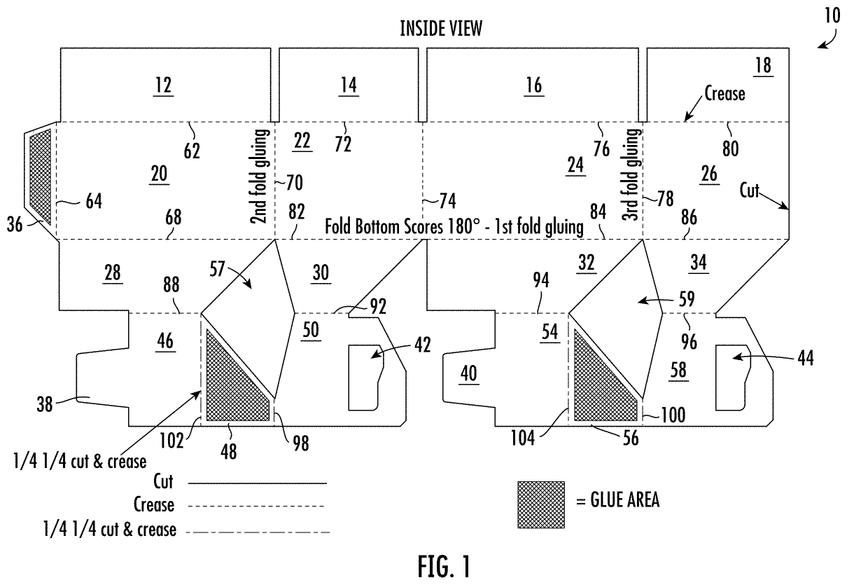

Referring now to the drawings for a better understanding of the invention, FIG. 1 illustrates a single blank 10 of foldable material. The foldable material may be paper-based material such as paperboard, although other materials may be used if desired. If used, the paperboard may, but need not be, corrugated and/or recycled.

FIGS. 1-4 illustrate blanks from which the unerected cartons with integrated partitions may be formed. In the drawings of the blanks, solid lines indicate cut lines and dashed lines indicate fold (crease) lines. The drawings also include cut and crease lines having a series of creases separated by cuts, where such lines often start and end with a crease. In some cases, the cut and crease lines have cuts that are ¼ inches long separated by creases that are ¼ inches long, although cuts and creases of various lengths could be used. Although the blanks include example dimensions, they are not intended to be limiting and the various panels, flaps, cut lines, fold lines, cut and crease lines, openings, etc. can have any suitable dimensions.

As illustrated in FIG. 1, blank 10 includes top flaps 12, 14, 16, 18 that are foldably connected to body panels 20, 22, 24 and 26 at fold lines 62, 72, 76, and 80, respectively. Top flaps 12, 14, 16 and 18 are separated from one another by cut lines that form slots between the top flaps 12, 14, 16 and 18. Body panels 20, 22, 24 and 26 are foldably connected to bottom flaps 28, 30, 32 and 34 at fold lines 68, 82, 84, 86, respectively. Bottom flap 28 is foldably connected to divider 46 at fold line 88; bottom flap 30 is foldably connected to divider 50 at fold line 92; bottom flap 32 is foldably connected to divider 54 at fold line 94; and bottom flap 34 is foldably connected to divider 58 at fold line 96. A tongue 38 extends from divider 46 and a tongue 40 extends from divider 54. Divider 50 defines an opening 42 and divider 58 defines an opening 44. When the blank is formed (as described below) into the unerected carton with integrated partition 60, tongue 40 is received in opening 42 and tongue 38 is received in opening 44 to help secure the partition walls in position. The openings 42 and 44 and the tongues 38 and 40 can have various shapes and sizes, as desired. FIGS. 1-4 illustrate a few examples of how the shapes and dimensions of the tongues and openings can vary.

Divider 46 is foldably connected to panel 48 about cut crease line 102, and panel 56 is foldably connected with divider 54 about cut crease line 104. Panel 56 is foldably connected to divider 58 at fold line 100, and panel 48 is foldably connected with divider 50 at fold line 98.

Bottom flaps 28 and 30 and panels 48 and 50 are shaped and arranged relative to one another so together they define a first opening 57 in the shape of a four-sided polygon (a quadrilateral). More specifically, one side of each of bottom flap 28, bottom flap 30, panel 48 and divider 50 are cut at an angle relative to the other sides of the respective flaps/panel/divider. Similarly, bottom flaps 32 and 34, panel 56 and divider 58 are shaped and arranged relative to one another so together they define a second opening 59 in the shape of a four-sided polygon (a quadrilateral). More specifically, one side of each of bottom flap 32, bottom flap 34, panel 56 and divider 58 are cut at an angle relative to the other sides of the respective flaps/panel/divider. The first and second openings 57, 59 serve as entry points for the panels and other components that form the integrated partition that provides separation for each cell of the erected carton, as described in more detail below. The first and second openings 57, 59 also provide relief to allow the materials to fold in various directions as desired. The size and shape of the first and second openings 57, 59 are driven by the dimensions of bottom flaps 32 and 34, panel 56 and divider 58 and thus can vary as desired. FIGS. 1-4 illustrate a few examples of how the shapes and dimensions of the first and second openings 57, 59 can vary.

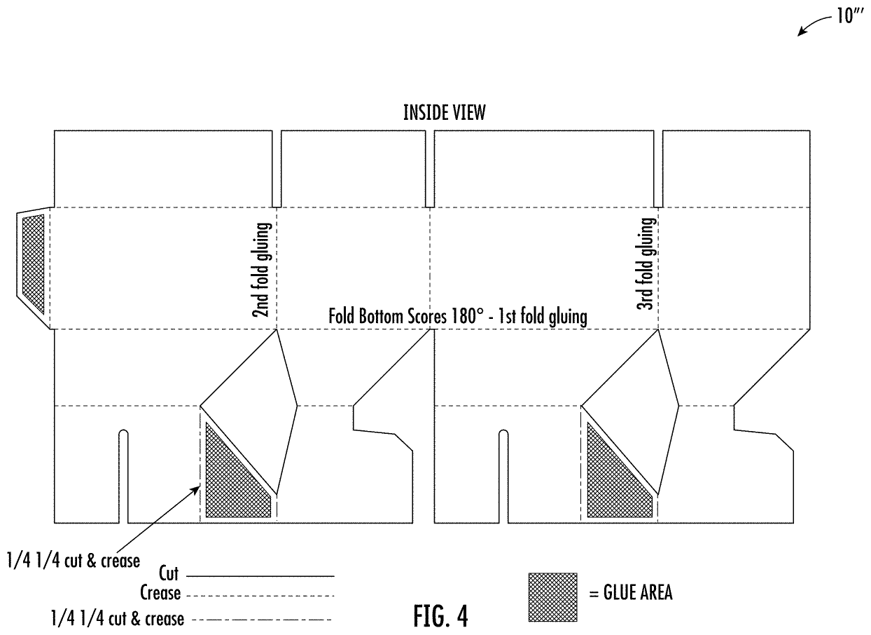

Blank 10 also includes a tab 36 that is foldably connected to body panel 20 at fold line 64. Any suitable adhesive is applied to the underside of tab 36 (the opposite side of tab 36 shown in FIG. 1), and tab 36 is attached to body panel 26 when forming the unerected carton with integrated partition 60. In other examples, as illustrated in FIG. 4, the underside of body panel 26 may receive adhesive instead of tab 36, and body panel 26 may be adhered to tab 36. Similarly, a suitable adhesive is applied to the underside of panel 48 (the opposite side of panel 48 shown in FIG. 1), and the underside panel 56 (the opposite side of the panel 56 shown in FIG. 1). When forming the unerected carton with integrated partition 60, the underside of panel 48 is adhered to the underside of divider 50, and the underside of panel 56 is adhered to the underside of divider 58. In other examples, the undersides of dividers 50 and 58 may receive adhesive instead of panels 48 and 56.

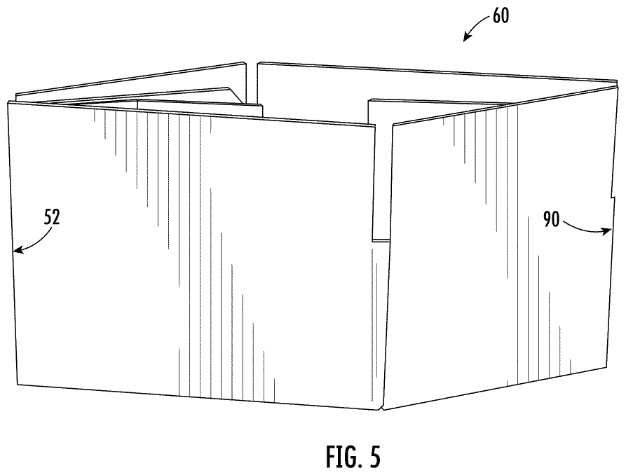

After adhesive is applied, the blank 10 is folded to form the unerected partition 60 shown in FIG. 5. In particular, the blank 10 is first folded about fold lines 68, 82, 84 and 86. The blank 10 is then folded about fold line 70, and finally about fold line 78 to form unerected carton with integrated partition 60.

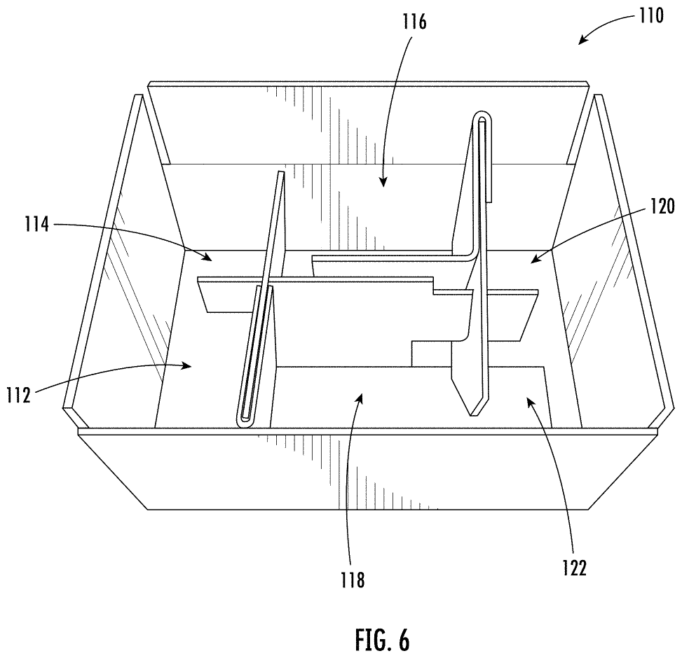

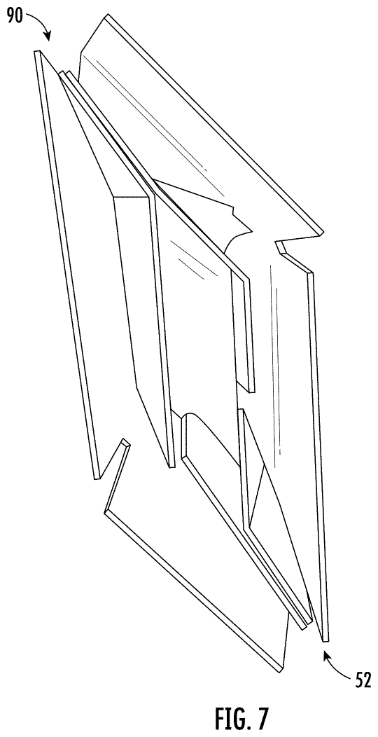

With reference to FIG. 5, to erect erected carton with integrated partition 110 shown in FIG. 6, a user applies force with one hand to corner 52 (which corresponds to fold line 70 of blank 10) and force with another hand to corner 90 (which corresponds to fold line 78 of blank 10), as shown in FIG. 7. This action urges unerected carton with integrated partition 60 (FIG. 5) to automatically snap into erected carton with integrated partition 110 (FIG. 6). Once erected, the bottom flaps 28, 30, 32 and 34 integrate together to form the bottom of the erected carton with integrated partition 110 without further assembly (sometimes referred to as an “auto bottom” or “automatic bottom”).

Referring to FIG. 6, erected carton with integrated partition 110 includes a carton having six cells. First cell 112 is formed from a portion of body panel 22, a portion of tongue 40 (the opposite side of the surface shown in the blank 10 of FIG. 1), a portion of divider 50, a portion of body panel 20 and a portion of bottom flap 30.

Second cell 114 is formed from the remaining portion of body panel 22, the opposite side of tongue 40 (the surface shown in the blank 10 of FIG. 1), the remaining portion of divider 50, a portion of body panel 24 and a portion of bottom flap 32.

Third cell 116 is formed from a portion of body panel 24, panel 56, a portion of divider 50 (the opposite side of the surface shown in the blank 10 of FIG. 1), divider 54 and a portion of bottom flap 32.

Fourth cell 118 is formed from a portion of body panel 20, panel 48, divider 46, a portion of panel 56 (the opposite side of the surface shown in the blank 10 of FIG. 1) and a portion of bottom flap 28.

Fifth cell 120 is formed from a portion of body panel 24, a portion of body panel 26, a portion of tongue 38 (the opposite side of the surface shown in blank 10 of FIG. 1), a portion of divider 58 and a portion of bottom flap 34.

Sixth cell 122 is formed from the remaining portion of body panel 26, a portion of tongue 38, the remaining portion of divider 58, a portion of body panel 20 and a portion of bottom flap 28.

One or more of the six cells can be filled with product or items as desired and the top flaps 12, 14, 16 and 18 can be folded about fold lines 62, 72, 76 and 80, respectively, and secured for shipment.

Although the carton is shown with six cells, the carton design can be modified to have any number of desired cells, such as four, eight, twelve, or more.

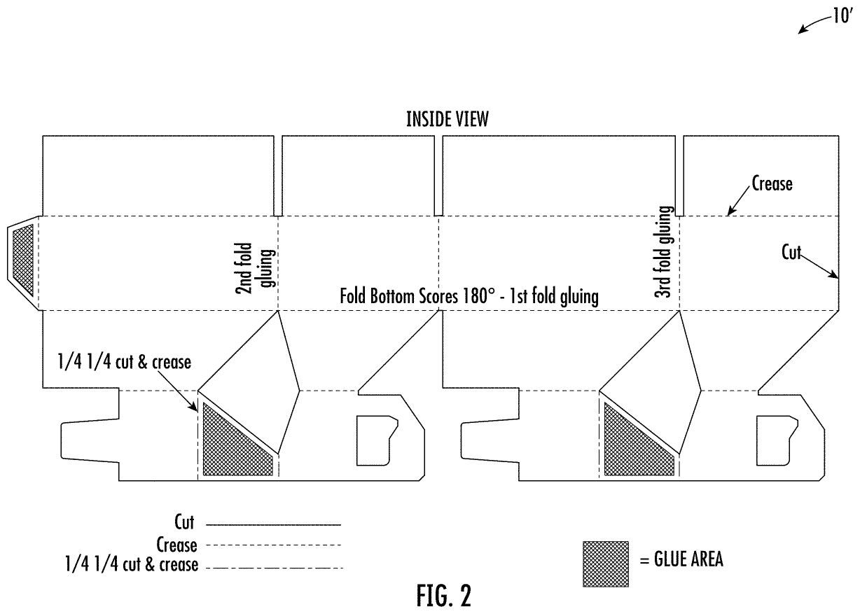

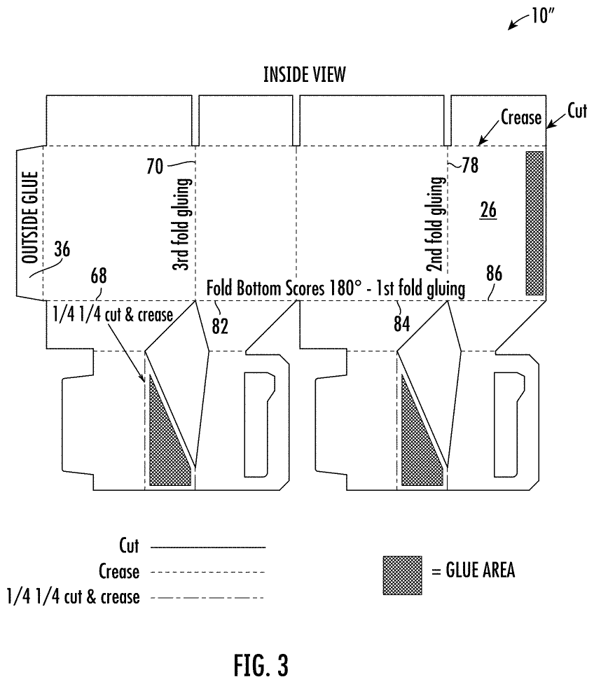

The blanks 10′, 10″ and 10′″ shown in FIGS. 2-4 are similar to blank 10 of FIG. 1, but with different dimensions and configurations for the various components. As another exemplary difference, the blank of FIG. 3 shows the application of adhesive to a portion of body panel 26 to be secured to tab 36 instead of vice versa, and thus has a slightly different folding order. In particular, after adhesive is applied, the blank is folded to form an unerected similar to partition 60 by first folding the blank about fold lines 68, 82, 84 and 86, then folding the blank about fold line 78 and finally about fold line 70.

As noted above, the design of blank 10 and similar blanks allow a user to easily erect a carton with integrated partition in one step, without needing to assemble various components relative to one another or worry about placing the correct panels into the corresponding slots. Instead, the unerected carton with integrated partition (as glued and folded) lays flat for shipment and a user can simply “pop” the unerected carton into position by grasping and applying force to the unerected carton about opposite corners. Because the unerected blank is already folded and glued into position for easy assembly, the erected carton with integrated partition easily collapses into its unerected position when a user squeezes the corners/presses adjacent sides of the carton toward one another. In this way, the carton with integrated partition moves easily and repeatedly between the erected and unerected positions, making it reusable since it does not have to be deassembled and reassembled between uses.

Also disclosed are methods of assembling the blanks into unerected cartons with integrated partitions, and methods for forming erected cartons with integrated partitions in a single step.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A blank for forming a carton with integrated partition, the blank comprising:
a plurality of top flaps each foldably connected with one of a plurality of body panels;
a plurality of bottom flaps each foldably connected with one of the plurality of body panels;
a plurality of dividers each foldably connected with one of the plurality of bottom flaps;
a first panel foldably connected with a first of the plurality of dividers and with a second of the plurality of dividers;
a second panel foldably connected with a third of the plurality of dividers and with a fourth of the plurality of dividers;
wherein a first and a second of the plurality of bottom flaps, the second of the plurality of the dividers and the first panel define a first opening;
wherein a third and a fourth of the plurality of bottom flaps, the fourth of the plurality of dividers and the second panel together define a second opening; and
wherein the plurality of top flaps, the plurality of body panels, the plurality of bottom flaps and the plurality of dividers are foldable relative to one another to form the carton with integrated partition.

2. The blank of claim 1, further comprising:
a first tongue extending from the first of the plurality of dividers;
a second tongue extending from the third of the plurality of dividers;
a first opening defined in the second of the plurality of dividers; and
a second opening defined in the fourth of the plurality of dividers,
wherein, when the carton with integrated partition is formed, the first tongue extends through the second opening and the second tongue extends through the first opening.

3. The blank of claim 1, wherein the first opening is a quadrilateral-shaped opening.

4. The blank of claim 3, wherein the second opening is a quadrilateral-shaped opening.

5. The blank of claim 1, wherein the blank is configured so that when the plurality of top flaps, the plurality of body panels, the plurality of bottom flaps and the plurality of dividers are folded relative to one another to form the carton with integrated partition,
wherein the carton is movable between an unerected position and an erected position,
and wherein, in the erected position, the carton with integrated partition defines six cells.

6. The blank of claim 2, wherein the blank is configured so that when the plurality of top flaps, the plurality of body panels, the plurality of bottom flaps and the plurality of dividers are folded relative to one another to form the carton with integrated partition,
wherein the carton is movable between an unerected position and an erected position,
and wherein, in the erected position, the carton with integrated partition defines six cells.

7. The blank of claim 6, wherein:
a first cell of the six cells is formed from at least part of a first of the plurality of body panels, at least part of the second tongue, at least part of the second of the plurality of dividers, at least part of a second of the plurality of body panels, and at least part of the second of the plurality of bottom flaps;
a second cell of the six cells is formed from at least part of the first of the plurality of body panels, at least part of the second tongue, at least part of the second of the plurality of dividers, at least part of a third of the plurality of body panels, and at least part of the third of the plurality of bottom flaps;
a third cell of the six cells is formed from at least part of the third of the plurality of body panels, at least part of the second panel, at least part of the second of the plurality of dividers, at least part of the third of the plurality of dividers, and at least part of the third of the plurality of bottom flaps;
a fourth cell of the six cells is formed from at least part of the second of the plurality of body panels, at least part of the first panel, at least part of the first of the plurality of dividers, at least part of the second panel, and at least part of the first of the plurality of bottom flaps;
a fifth cell of the six cells is formed from at least part of the third of the plurality of body panels, at least part of a fourth of the plurality of body panels, at least part of the first tongue, at least part of the fourth of the plurality of dividers, and at least part of the fourth of the plurality of bottom flaps; and
a sixth cell of the six cells is formed from at least part of the fourth of the plurality of body panels, at least part of the first tongue, at least part of the fourth of the plurality of dividers, at least part of the second of the plurality of body panels, and at least part of the first of the plurality of bottom flaps.

8. The blank of claim 1, wherein the first and second panels each comprise adhesive.

9. The blank of claim 1, wherein, when the plurality of top flaps, the plurality of body panels, the plurality of bottom flaps and the plurality of dividers are folded relative to one another to form the carton with integrated partition, the second panel is adhered to the second of the plurality of dividers and the first panel is adhered to the second of the plurality of dividers.

10. A carton with integrated partition, the carton comprising:
a plurality of top flaps;
a plurality of body panels;
a plurality of bottom flaps;
a plurality of dividers foldably connected to one of the plurality of bottom flaps;
a first panel foldably connected to a first of the plurality of dividers and to a second of the plurality of dividers;
a second panel foldably connected to a third of the plurality of dividers and to a fourth of the plurality of dividers;
wherein:
the plurality of top flaps, the plurality of body panels, the plurality of bottom flaps and the plurality of dividers are foldable relative to one another to form the carton with integrated partition;
the carton with integrated partition is movable between an unerected position and an erected position; and
in the erected position, the integrated partition separates the carton into six cells.

11. The carton of claim 10, further comprising:
a first tongue extending from the first of the plurality of dividers; and
a second tongue extending from the third of the plurality of dividers, and
wherein the integrated partition is made up of portions of a first of the plurality of body panels, a second of the plurality of body panels, a third of the plurality of body panels, a fourth of the plurality of body panels, the first tongue, the second tongue, the first of the plurality of bottom flaps, the second of the plurality of bottom flaps, the third of the plurality of bottom flaps, the fourth of the plurality of bottom flaps, the first of the plurality of dividers, the second of the plurality of dividers, the third of the plurality of dividers, the fourth of the plurality of dividers, the first panel, and the second panel.

12. The carton of claim 11, wherein:
a first cell of the six cells is defined by at least part of a first of the plurality of body panels, at least part of the second tongue, at least part of the second of the plurality of dividers, at least part of a second of the plurality of body panels, and at least part of the second of the plurality of bottom flaps;
a second cell of the six cells is defined by at least part of the first of the plurality of body panels, at least part of the second tongue, at least part of the second of the plurality of dividers, at least part of a third of the plurality of body panels, and at least part of the third of the plurality of bottom flaps;
a third cell of the six cells is defined by at least part of the third of the plurality of body panels, at least part of the second panel, at least part of the second of the plurality of dividers, at least part of the third of the plurality of dividers, and at least part of the third of the plurality of bottom flaps;
a fourth cell of the six cells is defined by at least part of the second of the plurality of body panels, at least part of the first panel, at least part of the first of the plurality of dividers, at least part of the second panel, and at least part of the first of the plurality of bottom flaps;
a fifth cell of the six cells is defined by at least part of the third of the plurality of body panels, at least part of a fourth of the plurality of body panels, at least part of the first tongue, at least part of the fourth of the plurality of dividers, and at least part of the fourth of the plurality of bottom flaps; and
a sixth cell of the six cells is defined by at least part of the fourth of the plurality of body panels, at least part of the first tongue, at least part of the fourth of the plurality of dividers, at least part of the second of the plurality of body panels, and at least part of the first of the plurality of bottom flaps.

13. The carton of claim 11, further comprising:
a first opening defined in the second of the plurality of dividers; and
a second opening defined in the fourth of the plurality of dividers,
wherein the first tongue extends through the second opening and the second tongue extends through the first opening.

14. The carton of claim 11, wherein the fourth of the plurality of body panels is adhered to a tab extending from a second of the plurality of body panels.

15. The carton of claim 11, wherein the second panel is adhered to the second of the plurality of dividers and the first panel is adhered to the second of the plurality of dividers.

16. A method of forming an unerected carton with integrated partition, comprising:
providing a blank comprising:
a plurality of top flaps each foldably connected with one of a plurality of body panels;
a plurality of bottom flaps each foldably connected with one of the plurality of body panels;
a plurality of dividers each foldably connected with one of the plurality of bottom flaps;
a first panel foldably connected with a first of the plurality of dividers and with a second of the plurality of dividers;
a second panel foldably connected with a third of the plurality of dividers and with a fourth of the plurality of dividers;
folding the blank along horizontal fold lines foldably connecting the plurality of bottom flaps with the plurality of body panels;
folding the blank along a first vertical fold line foldably connecting a first of the plurality of top flaps to a second of the plurality of top flaps; and
folding the blank along a second vertical fold line foldably connecting a third of the plurality of top flaps to a fourth of the plurality of top flaps.

17. The method of claim 16, further comprising applying adhesive to the first panel and the second panel before folding the blank.

18. The method of claim 16, further comprising adhering the second panel to the second of the plurality of dividers and adhering the first panel to the second of the plurality of dividers.

19. The method of claim 16, further comprising:
applying force to opposing corners of the unerected carton to erect the unerected carton into an erected carton, wherein the integrated partition separates an interior of the erected carton into a plurality of cells.

20. The method of claim 19, wherein the plurality of cells is six cells.

21. The method of claim 16, wherein providing the blank further comprises providing a blank wherein:
a first and a second of the plurality of bottom flaps, the second of the plurality of the dividers and the first panel define a first opening; and
a third and a fourth of the plurality of bottom flaps, the fourth of the plurality of dividers and the second panel together define a second opening.
